(19) United States
(12) Patent Application Publication
(10) Pub. No.: US 2025/0321122 A1
(43) Pub. Date: Oct. 16, 2025

(54) Position Sensor and Method for Redundantly Determining a Position

(71) Applicant: KNORR-BREMSE Systeme fuer Nutzfahrzeuge GmbH, Muenchen (DE)

(72) Inventor: Zeger BONTINCK, Muenchen (DE)

(21) Appl. No.: 19/173,908

(22) Filed: Apr. 9, 2025

(30) Foreign Application Priority Data
Apr. 10, 2024 (DE) 10 2024 109 983.6

(51) Int. Cl. G01D 5/14; G01D 18/00

(52) U.S. Cl. CPC G01D 5/14; G01D 18/008

(57) ABSTRACT

A position sensor for redundantly determining a position of an element which is able to be moved by a drive motor includes a primary sensor and a secondary sensor. The primary sensor is designed to sense the position of the movable element directly. The secondary sensor is designed to deduce the position of the movable element from at least one secondary measurement, the secondary measurement being based on a drive variable of the drive motor.

### CROSS REFERENCE TO RELATED APPLICATION

This application claims priority under 35 U.S.C. § 119 from German Patent Application No. 10 2024 109 983.6, filed Apr. 10, 2024, the entire disclosure of which is herein expressly incorporated by reference.

### BACKGROUND AND SUMMARY

The present invention relates to a position sensor and method for redundantly determining a position and, in particular, to hybrid strategies for controlling redundant electric motors in safety-critical applications, on the basis of sensor-based and sensorless control.

In safety-critical applications in particular, redundant detection or determination of a motor position is of great importance in order to be able to continue to determine motor positions even if one sensor fails. Redundant sensors can also be used to detect faults (e.g. if different measurements are present). These safety-critical applications include, for example, motor-controlled control of braking or steering operations but also engaging gears in gear-shifting units or other actuators. Redundant detections are used wherever a high level of reliability needs to be ensured. This means that a possibly occurring fault cannot cause the entire system to fail.

In conventional motors, for this purpose, use is made of position sensors, for example, which have a plurality of sensor elements. For example, position sensors are thus known which are based on the magneto-resistive effect and in which at least two chips are integrated in the position sensor (so-called “dual-die”). Therein, each chip can independently detect the position of the exemplary movable element. However, such multi-chip applications are usually very complex and expensive. Moreover, both chips are often affected by faults at the same time due to their spatial and functional proximity. A short circuit can thus affect both chips simultaneously. Likewise, an external fault can negatively influence all the chips using the same measuring principle.

There is therefore a need for alternatives to replace these multi-chip position sensors with simple position sensors without compromising the safety of the overall system.

At least some of these problems are solved by a position sensor and a method for detecting a position in accordance with the independent claims. The dependent claims refer to further advantageous configurations of the subject matter of the independent claims.

The present invention relates to a position sensor for redundantly determining a position of an element which is able to be moved by a drive motor. The position sensor comprises a primary sensor and a secondary sensor. The primary sensor is designed to sense the position of the movable element directly. The secondary sensor is designed to deduce the position of the movable element from at least one secondary measurement. The secondary measurement is based on a drive variable of the drive motor or on a variable caused by the movement of the drive motor.

The direct position detection of the primary sensor is to be understood to mean that the primary sensor detects the position of the movable element directly, for example by means of a magnetic or optical sensor, namely independently of the way in which the position of the movable element changes. In comparison thereto, the secondary sensor is a position sensor which does not detect the position of the movable element directly but rather detects a physical variable which defines the state of the drive motor (e.g. a movable element of the drive motor) in order to use this as a basis for enabling estimation of the change in position of the movable element. For example, a drive signal for an electric motor can be used for this purpose, from which it is possible to deduce how the position of the movable element has changed by the drive signal.

The secondary sensor therefore senses the cause or the consequence of the movement, while the primary sensor measures or detects the resulting movement. In this way, a plurality of different signal paths or different approaches are used to determine the motor position for each redundant path. The paths could be different types of encoder sensors, different algorithms for sensorless control, or use a combination of both approaches.

Optionally, the primary sensor is a position sensor which has at least one of the following sensor elements: a magneto-resistive element, a Hall effect sensor, an optical sensor, a resistance sensor.

Optionally, the secondary sensor determines (or estimates) the position of the movable element on the basis of at least one of the following variables:
a voltage signal for the drive motor,
a current signal for the drive motor,
an electromagnetic field caused by the drive motor,
a change in a magnetic field caused by the drive motor,
a duration of the drive for the drive motor,
a combination thereof.

Optionally, the position sensor comprises a magnetic element which is able to be attached to the movable element. The primary sensor can measure a change in the magnetic field caused by the movement of the magnetic element and determine the position therefrom.

Exemplary embodiments also relate to a drive apparatus having a drive motor and a movable element which is able to be moved by the drive motor. The drive apparatus comprises a position sensor as described previously.

Optionally, the drive motor is redundantly controllable via a first phase signal and a second phase signal, the first phase signal being based on sensor data from the primary sensor, and the second phase signal being based on sensor data from the secondary sensor. The first and the second phase signal can be so-called phase sets, each of which being designed to control the motor.

The drive motor can, for example, be an electric motor or a three-phase motor. However, it can also comprise a linear motor or other drive elements which are designed to move the movable element. The movement of the movable element can be, for example, a rotational, linear or axial movement, such as, for example, steering movements or braking operations, but also comprise movements of a shift fork in a transmission, which engages in shift elements to shift gears of a transmission. When the movable element performs rotational movements, the determined position is an angular position of the movable element. It is likewise possible for a combination of axial movements and rotational movements to be detected by the primary sensor and/or the secondary sensor in order to thus always still ensure reliable position determination if one of the two sensor elements fails.

Exemplary embodiments also relate to a method for redundantly determining a position of an element which is able to be moved by a drive motor. The method comprises:
directly detecting the position of the movable element by means of a primary sensor; and
deducing the position of the movable element by means of a secondary sensor on the basis of a drive variable of the drive motor.

Optionally, the method further comprises calibrating the secondary sensor by means of measurement data acquired by the primary sensor.

It is understood that the primary sensor can also be calibrated. For this purpose, the position can be determined via another measurement method. To calibrate the secondary sensor, the drive motor can perform a movement of the movable element, the movement of the movable element being detected by the primary sensor and simultaneously by the secondary sensor. The resulting calibration data can be stored accordingly in an evaluation device which can then-on the basis of sensor data from both sensor elements-carry out redundant detection of the position of the movable element.

It is understood that all of the previously described functions of the position sensor are performed as further optional method steps according to further exemplary embodiments. It is also understood that the listing sequence is not necessarily a sequence in which the method steps are performed. The steps can also be performed in another sequence. Also, only some of the method steps need to be performed.

The exemplary embodiments of the present invention will be better understood from the following detailed description and the attached drawings of the various exemplary embodiments, which however are not intended to be understood such that they restrict the disclosure to the specific embodiments, but rather serve merely for the purposes of explanation and understanding.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 shows a position sensor according to one exemplary embodiment of the present invention.

FIG. 2 is a schematic flowchart for a method for redundantly determining a position of a movable element according to one exemplary embodiment.

### DETAILED DESCRIPTION OF THE DRAWINGS

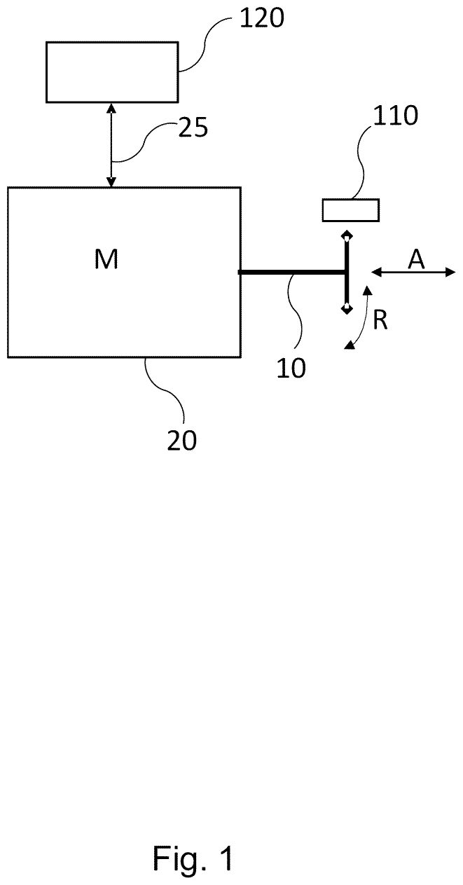

FIG. 1 shows one exemplary embodiment for the position sensor. The position sensor determines a position of an element 10 which is able to be moved by a drive motor 20. In this case, the movement may comprise an axial movement A and/or a rotational movement R. For determining the position of the movable element 10, the position sensor comprises a primary sensor 110 and a secondary sensor 120.

The primary sensor 110 detects the movement of the movable element 10 directly. This can be done, for example, via a magnetic-field measurement or an optical measurement and can be done independently of the drive motor 20. In other words, the reason for the movement has no influence on the position measurement itself whether, e.g., the element 10 is moved, for example, by the drive motor 20 or is moved by another apparatus.

In contrast, the secondary sensor 120 does not sense the movement of the element 10 directly but rather, for example, a physical variable which drives the drive motor 20 or which is caused by the driven drive motor 20. This physical variable can be, for example, a current signal or a voltage signal with which the drive motor 20 is driven. For example, zero crossings of the voltage or of the current may indicate a rotational position of the electric drive motor 20 when it is driven by an AC signal. The rotational position of the element 10 can then be estimated or determined from this. Equally, the physical variable may comprise a duration. The duration may be the length of the actuation of the drive motor 20, from which it is in turn possible to determine a distance which the movable element 10 has traveled while the drive motor 20 is actuated. The secondary sensor 120 can also use an indicated voltage or an induced current signal for measurement, which is caused by the movement of the drive motor 20 (e.g. by existing coils), the indicated voltage or the current signal not necessarily being the drive signal of the motor 20 directly but rather constituting a secondary signal which is generated, for example, by the rotor.

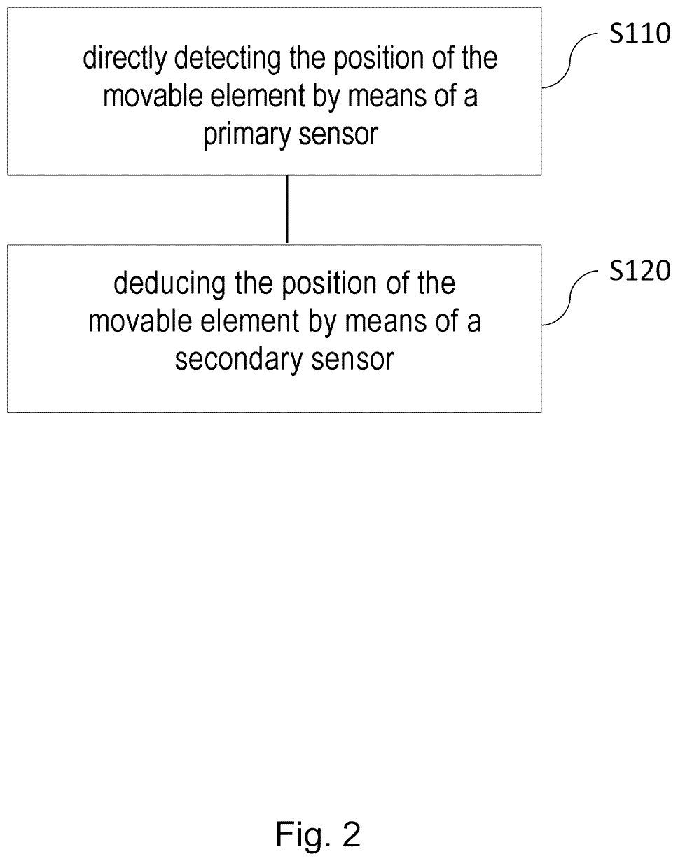

FIG. 2 shows a schematic flowchart for a method for redundantly determining a position of a movable element (as in FIG. 1) according to one exemplary embodiment. The method comprises at least the steps of:
directly detecting the position of the movable element 10 by means of a primary sensor 110; and
deducing the position of the movable element 10 by means of a secondary sensor 120 on the basis of a drive variable of the drive motor 20.

Optionally, the method comprises calibrating the secondary sensor 120 by means of measurement data acquired by the primary sensor 110. This can ensure that if the primary sensor 110 and the secondary sensor 120 are functioning correctly, sensor data indicating the same position are delivered. If there are differences, this may indicate a malfunction of a sensor.

It is understood that all of the previously described functions of the evaluation circuit can be designed as further optional method steps. It is also understood that the listing sequence is not necessarily a sequence in which the method steps are performed. The steps may also be performed in another sequence or only some of the method steps are performed.

The method may likewise be computer-implemented, i.e. it may be implemented through instructions which are stored on a storage medium and are capable of executing the steps of the method when it runs on a processor. The instructions typically comprise one or more instructions which are able to be stored in various ways on various media in or peripherally with respect to a control unit (having a processor) which, when they are read and executed by the control unit, prompt the control unit to execute functions, functionalities and operations that are necessary for performing a method according to the present invention.

Advantages of exemplary embodiments are, among other things, that very expensive dual sensor elements can be avoided for detecting the movement of the movable element 10. Such dual-die encoder sensors can therefore be replaced with lower-cost single-die variants which are then used as primary sensors 110. The desired redundancy is ensured via the secondary sensor 120.

Exemplary embodiments are thus able to be used in safety-critical applications for which redundant determination of motor positions is of crucial importance in order to enable a fail-operational mode. Since exemplary embodiments use a plurality of signal paths, one faulty signal path (e.g. due to a short circuit) cannot lead to a total failure. A fault cannot therefore lead to a non-functional state-unlike conventional dual-die motor position sensors or the conventional use of a plurality of position sensors, where one fault can render a plurality of sensors unusable. Thus, a major advantage is that the different ways of determining motor positions considerably reduce the possibility of collective faults. This significantly increases the safety of the product.

Moreover, exemplary embodiments offer the advantage of flexibly retrofitting or updating sensorless algorithms over time, even if a control unit is already installed in a vehicle. This enables the implementation of better algorithms and thus an increase in the motor power over time.

Overall, exemplary embodiments therefore reduce costs and increase flexibility without compromising safety.

Conventional motors for a level-4 steering system are designed, for example, as a 2×3 phase set (phase signals) (e.g. set 1: XYZ and set 2: ABC), each phase system being controlled via a redundant path and the motor position being determined by a dual-die encoder sensor (position sensor). According to exemplary embodiments, the dual-die encoder sensor could be replaced with a single-die sensor for one of the redundant paths. The currents required for the phase set XYZ are then calculated on the basis of the position indicated by the magnetic field of the encoder magnet on the motor shaft (as part of the primary sensor 110). This magnetic field is detected by the encoder sensor. For the other path (phase set ABC), a sensorless motor control algorithm could be used as the secondary sensor 120. Depending on the type of algorithm, the position of the rotor can be estimated, e.g., on the basis of the shape of the motor 20. This estimated position is then used to determine the required currents in the second phase set.

The features of the invention that are disclosed in the description, the claims and the figures may be essential both individually and in any desired combination for implementing the invention.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

10 movable element
20 drive motor (e.g. an electric motor)
25 secondary measurement
110 primary sensor
120 secondary sensor
A, R movements (axial or rotation)

What is claimed is:

1. A position sensor for redundantly determining a position of a movable element which is able to be moved by a drive motor, comprising:
a primary sensor configured to sense the position of the movable element directly; and
a secondary sensor configured to deduce the position of the movable element from at least one secondary measurement,
wherein the secondary measurement is based on a drive variable of the drive motor.

2. The position sensor as claimed in claim 1, wherein
the primary sensor is a position sensor comprising at least one of:
a magneto-resistive element,
a Hall effect sensor,
an optical sensor, or
a resistance sensor.

3. The position sensor as claimed in claim 1, wherein
the secondary sensor estimates the position of the movable element based on at least one of the following variables:
a voltage signal for the drive motor,
a current signal for the drive motor,
an electromagnetic field caused by the drive motor,
a change in a magnetic field caused by the drive motor, or
a duration of the drive for the drive motor.

4. The position sensor as claimed in claim 1, further comprising:
a magnetic element which is able to be attached to the movable element,
wherein the primary sensor measures a change in a magnetic field caused by movement of the magnetic element.

5. A drive apparatus, comprising:
a drive motor;
a movable element which is able to be moved by the drive motor; and
a position sensor for redundantly determining a position of the movable element, the position sensor comprising:
a primary sensor configured to sense the position of the movable element directly; and
a secondary sensor configured to deduce the position of the movable element from at least one secondary measurement,
wherein the secondary measurement is based on a drive variable of the drive motor.

6. The drive apparatus as claimed in claim 5, wherein
the drive motor is redundantly controllable via a first phase signal and a second phase signal,
the first phase signal is based on sensor data from the primary sensor, and
the second phase signal is based on sensor data from the secondary sensor.

7. A method for redundantly determining a position of a movable element which is able to be moved by a drive motor, the method comprising the steps of:
directly detecting the position of the movable element via a primary sensor; and
deducing the position of the movable element via a secondary sensor on the basis of a drive variable of the drive motor.

8. The method as claimed in claim 7, further comprising:
calibrating the secondary sensor by use of measurement data acquired by the primary sensor.
